(19) United States
(12) Patent Application Publication
(10) Pub. No.: US 2023/0032762 A1
(43) Pub. Date: Feb. 2, 2023

(54) Universal load take-up device for dumper wheel rim

(71) Applicant: ETABLISSEMENTS GEORGES RENAULT, Saint Herblain (FR)

(72) Inventor: Régis Bonnet, SAINTE LUCE SUR LOIRE (FR)

(21) Appl. No.: 17/788,542

(22) PCT Filed: Dec. 14, 2020
(86) PCT No.: PCT/EP2020/086009

§ 371 Date: Jun. 23, 2022

(30) Foreign Application Priority Data
Dec. 24, 2019 (FR) 1915572

(51) Int. Cl. B60B 29/00

(52) U.S. Cl. CPC B60B 29/007; B60B 2900/541

(57) ABSTRACT

A load take-up device suitable for being secured to a screwing/unscrewing tool implemented to ensure the securing/release of a dumper wheel attached to a support by screwing elements. The device includes: a plate; a bearing surface secured to the plate; a blocking element blocking rotation of the plate with respect to the screwing/unscrewing tool along the crewing/unscrewing axis of the tool; and at least one element forming a bearing. The element forming the bearing is secured to the plate and disposed with the bearing surface on either side of the blocking element, the element forming the bearing and the bearing surface being intended to bear against two opposite surfaces of the wheel in order to take up forces due to the screwing/unscrewing of the screwing elements, the at least one element forming the bearing being able to be secured to the plate reversibly in at least two positions.

### 1. CROSS-REFERENCE TO RELATED APPLICATIONS

This Application is a Section 371 National Stage Application of International Application No. PCT/EP2020/086009, filed Dec. 14, 2020, which is incorporated by reference in its entirety and published as WO 2021/130043 A1 on Jul. 1, 2021, not in English.

### 2. FIELD OF THE INVENTION

The field of the invention is that of tools implemented for carrying out the maintenance of wheels of the dumper type.

The invention more particularly relates to a load take-up device suitable for being secured to a screwing/unscrewing tool intended to be implemented to ensure the securing/release of a dumper wheel.

### 3. PRIOR ART

Dumper wheels are conventionally used, particularly in the agricultural fields, earthworks, building and construction works industry, etc., to move various machinery on soil.

A dumper wheel comprises a hub and a rim around which is placed a tyre.

In the case of a demountable rim wheel, the rim may be secured to the hub by means of one or more rows of screwing elements such as screws, nuts, bolts, etc. that are tightened with a considerable tightening torque, for example greater than or equal to approximately 1,000 N.m. The hub is attached to the vehicle.

In the case of a one-piece wheel, the rim and the hub are inseparable from one another, and the wheel as a whole is secured to the vehicle by means of one or more rows of screwing elements such as screws, nuts, bolts, etc. that are tightened with a considerable tightening torque, for example greater than or equal to approximately 1,000 N.m.

The maintenance of a wheel of this type, for example in order to carry out the repair or the replacement of the tyre placed around the rim, may require separating the rim from the hub (case of a demountable rim wheel) or the whole wheel (case of a one-piece wheel) then assembling the rim on the hub or the whole wheel on the vehicle.

Given the high value of the tightening torque to which the screwing means are tightened to ensure the assembly of the wheel, it is necessary, particularly during the unscrewing, to use a load take-up device in order to take up the reaction loads due to the unscrewing. Indeed, it is impossible for an operator to support such reaction loads.

FIG. 1 illustrates a known load take-up device that comprises a plate 10 at the surface of which extends a plurality of trunnions 11 (generally four). This plate 10 is secured fixedly in rotation to the end of the screwing/unscrewing tool 12 and some at least of the studs 11 are placed bearing against the rim 13 in order to block the rotation of the screwing/unscrewing tool 12 with respect to the rim 13. Thus, during an unscrewing, the reaction loads are supported by the rim.

Such load take-up devices are effective in that they make it possible to effectively support considerable reaction loads and thus make it possible for an operator to carry out the assembly and disassembly of a dumper wheel.

However, dumper wheels have rims and/or hubs of different dimensions according to the brands and models to the extent that maintenance companies are forced to resort to the use of a fairly significant bank of load take-up devices in order to carry out the maintenance of the wheels of various vehicles.

This is cumbersome, expensive and not very practical in particular when an operator must intervene on site, for example in a quarry, a mine or a construction site in order to maintain a plurality of vehicles of different types.

### 4. SUMMARY

For this, the invention proposes a load take-up device suitable for being secured to a screwing/unscrewing tool intended to be implemented to ensure the securing/release of a dumper wheel attached to a support by screwing elements.

According to the invention, such a device comprises at least:

one plate,

one bearing surface secured to said plate;

means for blocking the rotation of said plate with respect to said screwing/unscrewing tool along the screwing/unscrewing axis of said tool,

at least one element forming a bearing,

said element forming a bearing being secured to said plate and disposed with said bearing surface on either side of said means for blocking the rotation, said element forming a bearing and said bearing surface being intended to bear against two opposite surfaces of said wheel in order to take up the forces due to the screwing/unscrewing of said screwing elements, said at least one element forming a bearing being able to be secured to said plate reversibly in at least two positions.

Thus, the invention is based on an original approach according to which the load take-up device comprising a plate and at least one element forming a bearing likely to be secured to the plate in a plurality of positions.

These various positions make it possible to modify the position of the contact surfaces of the load take-up device with the dumper wheel such as to be able to be effectively adapted to various wheel models.

A device according to the invention thus makes it possible to effectively take up the screwing/unscrewing loads during the dismantling of wheels of various dumper wheel models, which gives it significant versatility.

The use of a device according to the invention thus facilitates the task of operators working on the maintenance of dumper wheels by reducing the number of tools that they must bring during the intervention. This makes it possible to reduce the area needed for storing load take-up devices. This also makes it possible to reduce the cost of investment in these devices.

A dumper wheel may be of the one-piece type, i.e. the rim is inseparable from the hub that is attached on a support equipping a vehicle.

A dumper wheel may be of the demountable rim type, i.e. the rim can be released from the hub that is attached to the vehicle. In this case, the hub ensures the support function.

Within the meaning of the invention:

in the case of a wheel of the one-piece type, the securing/release of the wheel involves securing/releasing the complete wheel to/from its support;

in the case of a demountable rim wheel, the securing/release of the wheel involves securing/releasing the rim to/from its hub.

According to a possible feature, said at least one element forming a bearing comprises a lug comprising at least two adjustment slots, suitable for receiving said plate, each of said slots defining one of said positions of said lug with respect to said plate.

It is thus possible to place the lug in various predetermined positions corresponding to various wheel models, which gives the device significant versatility. Furthermore, the implementation of such slots makes effective load take-up possible in a simple manner, which improves safe use.

According to a possible feature, adjustment slots are arranged on two opposite faces of said lug.

The simple turning over of the lug offers other positions of use. This improves in a simple manner the versatility of the device.

According to a possible feature, said bearing surface is a surface of said plate.

In this case, the plate is used as a bearing element.

According to a possible feature, a device according to the invention comprises a stud secured to said plate, said bearing surface being a surface of said stud.

In this case, a stud ensures the bearing element function rather than the plate.

According to a possible feature, said element forming a bearing comprises a peripheral edge having at least one contact surface in an arc of circle of axis parallel to the axis of said screwing/unscrewing tool and intended to bear against said opposite surfaces of said wheel.

This makes it possible to guarantee that the contact between the wheel and the lug is linear.

According to a possible feature, the peripheral edge comprises said contact surface in an arc of circle the opposite ends of which are joined by two flat and straight contact surfaces.

This makes it possible to guarantee a reduced overall size to make it possible to pass the device between the rim and the hub.

According to a possible feature, a device according to the invention comprises means for holding in position said lug with respect to said plate in each of said positions of said lug.

The lug may thus be secured to the plate during the transport or the movement of the device.

According to a possible feature, said means for blocking the rotation are removable and interchangeable from a group of a plurality of means for blocking the rotation adapted to different screwing/unscrewing tools.

It is thus possible to easily adapt a device according to the invention on various tool models, which gives it significant versatility.

According to a possible feature, a device according to the invention comprises at least one stud likely to be secured to said plate without said lug in order to form a second bearing surface intended to bear against one of the two opposite surfaces instead of said lug.

Rather than using the lug, it is possible to use a simple stud. The device according to the invention may therefore be used on other wheel models which also improves its versatility.

According to a possible feature, said stud or studs are removable.

This facilitates the dismantling and the replacement of studs during maintenance operations during which the defective studs are replaced. This may also make it possible to replace the studs of shapes and/or dimensions with studs of different shapes and/or dimensions in order to adapt to another wheel model and thus improve the versatility of the device.

### 5. DESCRIPTION OF THE FIGURES

Other features and advantages of the invention will become apparent upon reading the following description of particular embodiments, given by way of simple illustrative and non-limiting example, and the appended figures, wherein:

FIG. 1 illustrates a load take-up device according to the prior art;

FIG. 2 illustrates a side view of a variant of a device according to the invention comprising a stud and a lug;

FIG. 3 illustrates an exploded view of a variant of a device according to the invention comprising two studs;

FIG. 4 illustrates the interaction of a device of FIG. 2 with a dumper wheel;

FIG. 5 illustrates the interaction of a device of FIG. 3 with a dumper wheel;

FIG. 6 illustrates the interaction of a device of FIG. 2 with a dumper wheel with the lug in another position;

FIG. 7 illustrates another view of a variant of a device according to the invention comprising a lug only, the plate bearing directly against a surface of the wheel;

FIG. 8 illustrates another view of an interaction of a device of FIG. 2 with a dumper wheel;

FIG. 9 illustrates another view of an interaction of a device of FIG. 2 with a dumper wheel;

FIG. 10 illustrates another view of an interaction of a device of FIG. 2 with a dumper wheel;

FIG. 11 illustrates another view of an interaction of a device of FIG. 2 with a dumper wheel;

FIG. 12 illustrates another view of an interaction of a device of FIG. 3 with a dumper wheel.

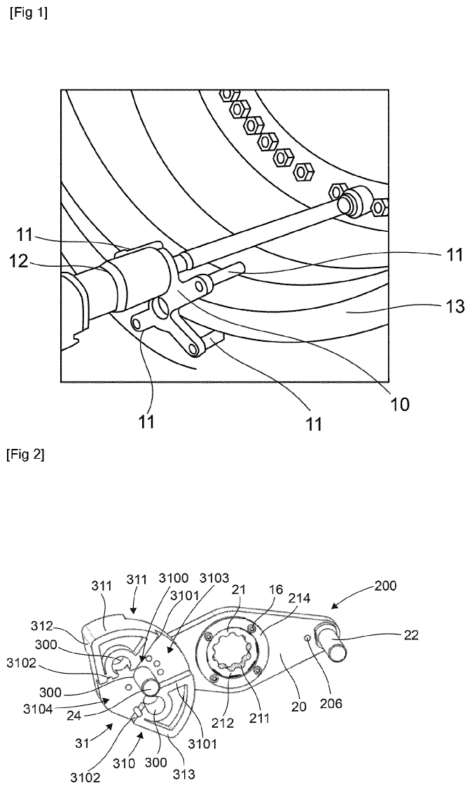

### 6. DESCRIPTION OF PARTICULAR EMBODIMENTS

6.1. Architecture

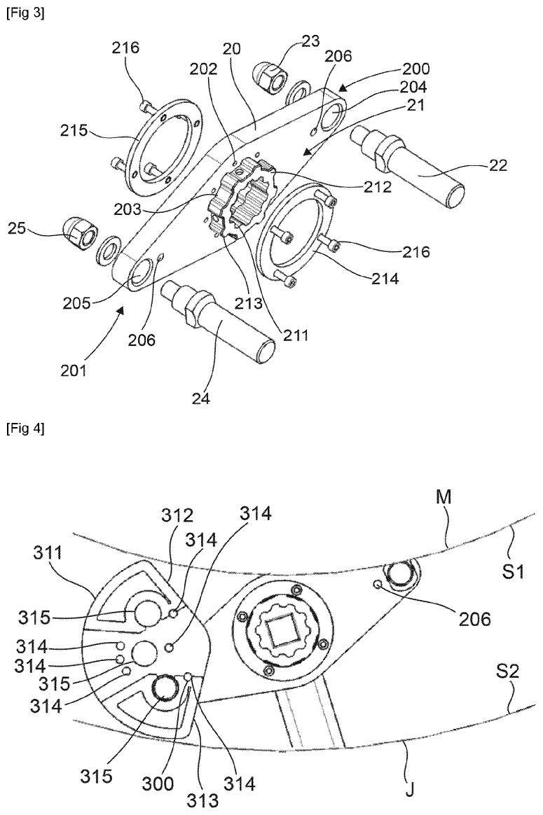

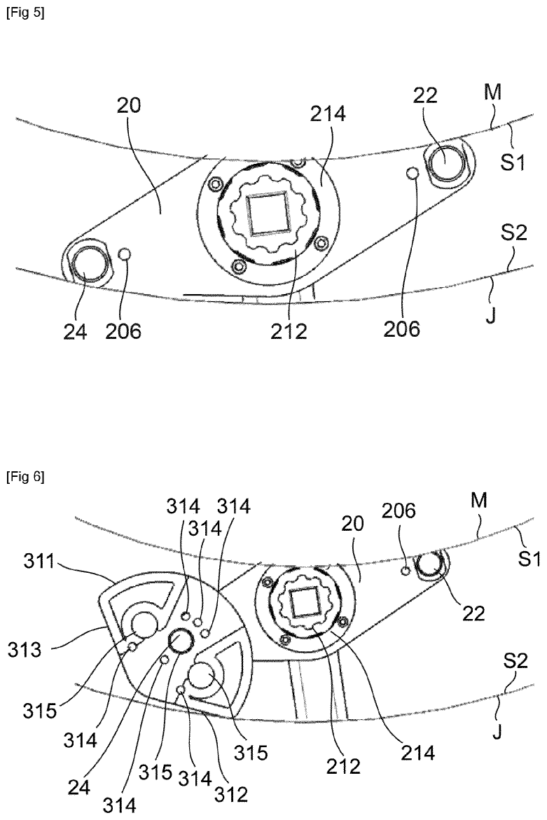

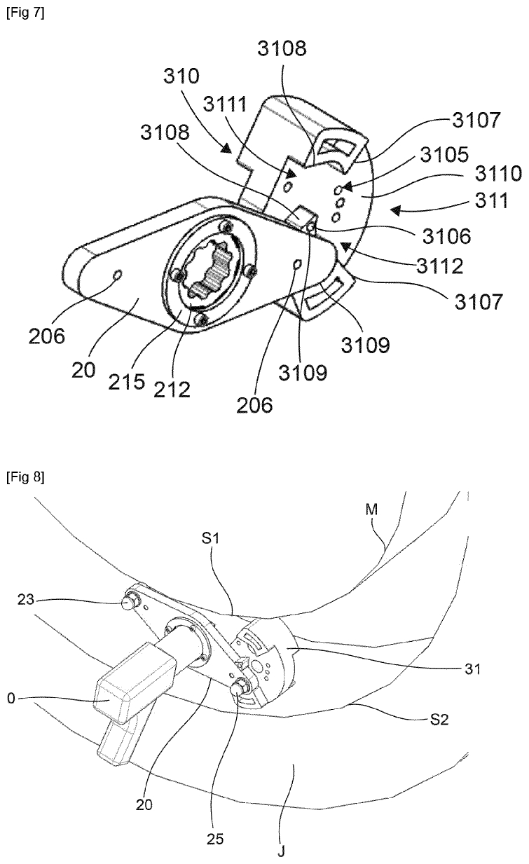

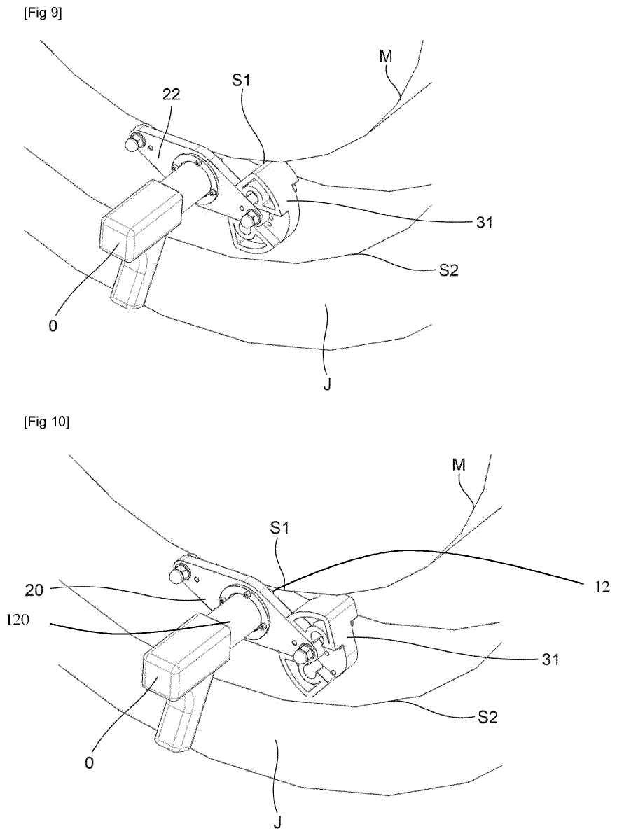

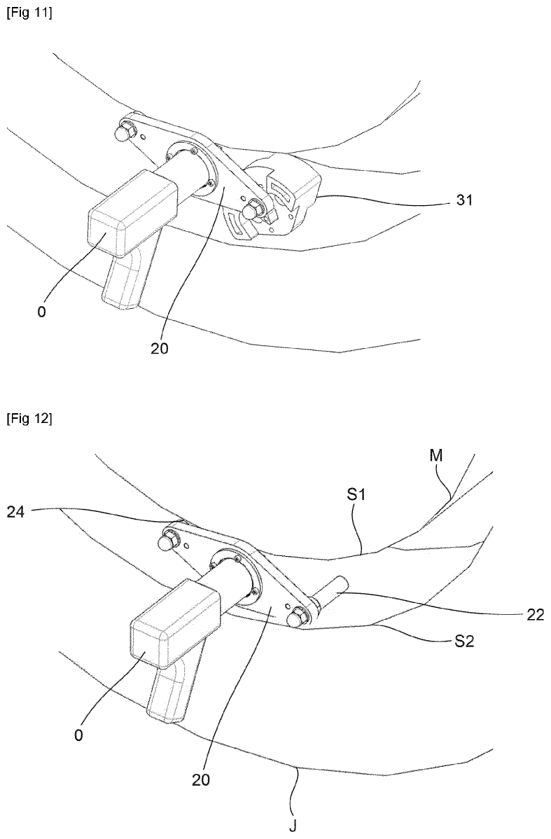

In relation with FIGS. 2 to 12 an example of a load take-up device according to the invention is presented.

Thus as shown, such a device comprises a plate 20. This plate 20 essentially has a flatten rhomb shape having a first 200 and a second 201 distal end. The shape of the plate may however be different. It is in the shape of a plate preferably made of metal material or any other plastic material, composite or other likely to support the reaction loads.

This plate 20 comprises at its centre means for blocking the rotation 21 with respect to a screwing/unscrewing tool along the screwing/unscrewing axis of the tool.

These means for blocking the rotation 21 comprise here inner ribs 211 of complementary shape to the ribs (not shown) arranged at the end of the tool and extending along the screwing axis of the latter.

Other blocking means may alternatively or additionally be implemented such as for example a pin integral with the tool provided in order to cooperate with a groove arranged in the plate, or inversely, a clamp or other.

It may be envisaged that the ring 212 is adaptable to various tool brands and models: for example the ring may be delivered smooth, and it is the user who is responsible for machining (or more generally shaping) it so that it ensures the role of interface between the plate and its tool.

The inner ribs 211 are arranged on a ring 212 also having outer ribs 213. This ring 212 is inserted into a bore 202 of the plate 20 having grooves 203 of complementary shape. This ring 212 is rotatably blocked with respect to the plate due to the fact of the cooperation of the ribs 213 and 203. It is held laterally secured to the plate by means of a set of two plates 214, 215 holding tightly the ring 212 and the plate 20 by means of screws 216.

The blocking means are thus removable. They may be interchanged from a group of a plurality of means for blocking the rotation adapted to different screwing/unscrewing tools. It is thus possible, depending on the tool to which it is desired to secure the load take-up device, to replace the ring 212 with another ring of adapted shape.

This interchangeability principle may also be implemented in the variants of the means for blocking the rotation implementing means alternative to the ribs (for example clamp, pins, etc.).

The distal ends 200 and 201 of the plate 20 are each penetrated by a hole 204, 205 of axis essentially parallel to the axis of the bore 202.

The device comprises a first stud 22 an end of which penetrates the hole 204 and that is secured to the plate by means of a nut 23.

The device also comprises a second stud 24 an end of which penetrates the hole 205 and that is secured to the plate by means of a nut 25.

According to a first variant, these first and second studs constitute elements forming a bearing.

According to a second variant, only the first stud constitutes an element forming a bearing. The second stud is then used to secure to the plate another element forming a bearing comprising a lug 31.

The device then comprises a lug 31.

Other variants are also envisaged:

no stud (see FIG. 7): in this case, a first bearing is carried out on the plate and a second bearing is carried out on the lug (load take-up via conformation of the lug);

a single stud.

In addition the studs may only bear on the edge of the rim. The device with the studs only shows one variant of the invention, the essential being the presence of the lug. This lug is not necessarily attached to the plate by the stud. It may be attached thereto by any other means. The load take-up is carried out by the conformation of the lug and/or of the plate.

This lug 31 is able to be secured to the plate 20 reversibly in at least two positions as described in more detail below.

For this, the lug 31 is penetrated by a plurality of attachment bores 315, here three. This number of holes will generally be greater than or equal to two.

These holes make it possible to attach the lug 31 to the plate 20 by means of the second stud 24 at the second distal end 201. Alternatively, this securing may alternatively be performed by means of a bolt, of a shaft and of a pin or other, etc. For example, the lug may be positioned without stud, only by the conformation of the lug. It then has a complementary shape to that of the plate.

The lug 31 comprises two opposite lateral faces 310, 311.

Slots are arranged on these faces in order to cooperate with the corresponding distal end of the plate. As will become more apparent in the following, it is these slots that take up the reaction loads.

More specifically, the face 310 has a recess 3100 defined by a first pair of walls 3101 and by a second pair of walls 3102 that essentially extend parallel to the corresponding peripheral faces of the plate when the lug is secured to the plate.

The pair of walls 3101 defines a first slot 3103 suitable for receiving a distal end of the plate.

The pair of walls 3102 defines a second slot 3104 suitable for receiving a distal end of the plate.

Each of the slots 3103 and 3104 defines a different position of the lug with respect to the plate. Each of these positions corresponds to a different orientation of the lug with respect to the plate. These positions are connected to the spacings between the hub and the rim, and to the position of the nut, corresponding to the various dumper sizes and models.

The face 311 has a recess 3105 and a central lug 3106 defined by a third pair of walls 3107, a fourth pair of walls 3108 and by a fifth pair of walls 3109 that essentially extend parallel to the corresponding peripheral faces of the plate when the lug is secured to the plate.

The pair of walls 3107 defines a third slot 3110 suitable for receiving a distal end of the plate.

The pair of walls 3108 defines a fourth slot 3111 suitable for receiving a distal end of the plate.

The pair of walls 3109 defines a fifth slot 3112 suitable for receiving a distal end of the plate.

Each of the slots 3111 and 3112 defines a different position of the lug with respect to the plate.

The slot 3110 defines in reality two positions, one wherein the plate comes into contact with one of the walls 3107 and a second position wherein the plate bears against the other of the walls 3107.

In the embodiment described here, the lug may therefore take six different positions with respect to the plate.

Each of these positions makes it possible to modify the general overall size of the device such as to be able to use it to perform the maintenance of wheels of different sizes.

The lug 31 comprises a peripheral edge having in this embodiment a contact surface 311. It is intended to bear against opposite surfaces arranged on the rim J and/or on the hub M of a dumper wheel.

The contact surface 311 is in an arc of circle of axis parallel to the axis of the screwing/unscrewing tool.

The opposite ends of the contact surface 311 are in this embodiment joined by two surfaces 312 and 313 that are flat and straight.

The surfaces 311, 312 and 313 may nevertheless have other shapes.

The lug may include a plurality of contact surfaces. The bearing surfaces are only curved in such a way that the bearings are only linear.

The flat surfaces 312 and 313 may not be used as bearings because they would not be in correct contact with the rim.

The lug is penetrated by three attachment bores 315 in order to make its securing to the plate possible in a plurality of positions by means of a stud 22, 24 or of any other adapted means such as a bolt, a screw, a shaft with pin(s) or other. The bores and the studs are only used for positioning the lug and not for the load take-up.

The device comprises means for holding the lug on the plate, particularly during the transport or movement of the device. For this, the plate 20 is penetrated at each of its distal ends by a hole 206 and the lug 30 is penetrated by holes 314. In each of the positions of the lug with respect to the plate, a hole 314 of the lug is aligned with a hole 206 of the plate. A blocking element, such as for example a shaft 300, a pin, a bolt, a screw or other may then be inserted into the aligned holes in order to hold the lug and secure the rotation of the plate.

6.2. Operation

The operation of a securing device according to the invention will now be described. In order to carry out the assembly or the disassembly of a dumper wheel, an operator brings a screwing/unscrewing device and at least one load take-up device according to the invention.

The screwing/unscrewing tool 0 is conventionally a motorised tool, particularly with continuous tightening. Such a screwing/unscrewing device 0 comprises a housing 120, housing a motor, and an output shaft, rotatably mounted with respect to the housing along the screwing/unscrewing axis, at the end 12 of which may be secured a screwing end piece suitable for cooperating with an element to be screwed/unscrewed. An extension may optionally be interposed between the end 12 of the output shaft and the screwing end piece.

The operator first chooses the means for blocking the rotation adapted to the screwing/unscrewing tool 0. In the embodiment described above, this amounts to choosing the ring 212 adapted to the tool then to securing it to the plate 20 by means of plates 214, 215 and screws 216.

According to the dumper wheel model of which the maintenance must be ensured, the operator chooses to secure to the plate:

a lug 31 only;

a stud 22, 24 and a lug 31;

two lugs 31.

6.2.1. A Single Lug

To meet their needs, the operator may only need to secure a single lug 31 to the plate. Before securing the lug to the plate, the operator chooses the required position of the lug with respect to the plate. They thus insert a distal end of the plate into the appropriate slot of the lug and secure it to the plate for example by passing through a stud or another ad hoc means for attaching in the bore 315 or by simply making the lug cooperate with the plate if the cooperation of their respective shapes is sufficient to ensure the secure holding.

They subsequently secure the plate 20 to the screwing/unscrewing tool 0 by means of adapted means for blocking the rotation. The means for blocking the rotation of the plate 20 with respect to the screwing/unscrewing tool 0 along the screwing/unscrewing axis of the tool 0 make it possible to immobilise the rotation, about the screwing/unscrewing axis, of the housing with respect to the plate.

They subsequently make the socket placed at the end of the tool cooperate with the screwing element to be unscrewed or to be screwed.

They also place a portion of the peripheral surface of the plate and the contact surface of the lug in contact with opposite surfaces of the rim and/or of the hub of the wheel. If the position retained for the lug is not suitable, the operator may dismantle the lug and place it in that of its positions the most adapted to the wheel during maintenance. During the screwing or unscrewing of the elements to be screwed or unscrewed, a portion of the peripheral surface of the plate and the contact surface of the lug bear against the opposite surfaces of the rim and/or of the hub of the wheel thus blocking the rotation of the screwing tool about the screwing/unscrewing axis, whereas the output shaft at the end of which is a screwing end piece cooperating with an element to be screwed/unscrewed, is rotated. In doing so, the reaction loads due to the screwing/unscrewing are transmitted by the load take-up device to the wheel. More specifically, the reaction torque resulting from the tightening torque following the screwing/unscrewing axis is supported by the load take-up device. This reaction torque along the screwing/unscrewing axis of the tool passes through the housing of the tool to which the plate is connected by the intermediary of means for blocking the rotation of the plate with respect to the screwing/unscrewing tool, these means being in this embodiment made up of the ribs.

6.2.2. A Stud and a Lug

If for their needs, the operator desires to secure to the plate a stud 22, 24, and a lug 31, they secure the stud to the plate by means of the corresponding nut and they secure the lug to the plate by means of the corresponding stud.

Before securing the lug to the plate, the operator chooses the required position of the lug with respect to the plate. They thus insert a distal end of the plate into the appropriate slot of the lug and secure it to the plate by passing through the stud or another ad hoc means for attaching in the bore 315 or by simply making the lug cooperate with the plate if the cooperation of their respective shapes is sufficient to ensure secure holding.

They subsequently secure the plate 20 to the screwing/unscrewing tool 0 by means of adapted means for blocking the rotation. The means for blocking the rotation of the plate 20 with respect to the screwing/unscrewing tool 0 along the screwing/unscrewing axis of the tool 0 make it possible to immobilise the rotation, about the screwing/unscrewing axis, of the housing with respect to the plate.

They subsequently make the socket placed at the end of the tool cooperate with the screwing element to be unscrewed or to be screwed.

They also place the studs 23, 24 (other than that optionally being used to secure the lug) and the contact surface of the lug in contact with opposite surfaces of the rim and/or of the hub of the wheel.

If the position retained for the lug is not suitable, the operator may dismantle the lug and place it in that of its positions the most adapted to the wheel during maintenance.

During the screwing or unscrewing of the elements to be screwed or unscrewed, the stud and the contact surface of the lug bear against the opposite surfaces of the rim and/or of the hub of the wheel thus blocking the rotation of the screwing tool about the screwing/unscrewing axis, whereas the output shaft at the end of which is a screwing end piece cooperating with an element to be screwed/unscrewed, is rotated. In doing so, the reaction loads due to the screwing/unscrewing are transmitted by the load take-up device to the wheel. More specifically, the reaction torque resulting from the tightening torque following the screwing/unscrewing axis is supported by the load take-up device. This reaction torque along the screwing/unscrewing axis of the tool passes through the housing of the tool to which the plate is connected by the intermediary of means for blocking the rotation of the plate with respect to the screwing/unscrewing tool, these means being in this embodiment made up of the ribs.

6.2.3. Two Lugs

If for their needs, the operator desires to secure to the plate two lugs 31, they secure a lug to each distal end of the plate by proceeding as has just been described for a single lug.

6.3. Variant

It may be provided that one and/or the other of the distal ends of the plate are penetrated by a plurality of holes 204, 205 in order to make it possible to secure one or more studs in different positions.

An exemplary embodiment of the invention provides an effective solution to at least some of these various problems.

At least one embodiment procures a load take-up device that is versatile.

Particularly, at least one embodiment provides such a load take-up device that can be used to carry out the maintenance of different dumper wheels.

At least one embodiment provides such a load take-up device that is of simple design.

Particularly, at least one embodiment provides such a load take-up device that is robust.

At least one embodiment provide such a load take-up device that is easy to maintain.

At least one embodiment provides such a load take-up device that is reliable and effective.

Although the present disclosure has been described with reference to one or more examples, workers skilled in the art will recognize that changes may be made in form and detail without departing from the scope of the disclosure and/or the appended claims.

1. A load take-up device suitable for being secured to a screwing/unscrewing tool intended to be implemented to ensure the securing/release of a dumper wheel attached to a support by screwing elements, said device comprising at least:
a plate,
a bearing surface secured to said plate,
a blocking element, which blocks rotation of said plate with respect to said screwing/unscrewing tool along the screwing/unscrewing axis of said tool,
at least one element forming a bearing,
said element forming the bearing being secured to said plate and disposed with said bearing surface on either side of said blocking element, said element forming the bearing and said bearing surface being configured to bear against two opposite surfaces of said wheel in order to take up forces due to the screwing/unscrewing of said screwing elements, said at least one element forming the bearing being securable to said plate reversibly in at least two positions.

2. The load take-up device according to claim 1 wherein said at least one element forming the bearing comprises a lug comprising at least two adjustment slots suitable for receiving said plate, each of said slots defining one of said positions of said lug with respect to said plate.

3. The load take-up device according to claim 2 wherein said adjustment slots are arranged on two opposite faces of said lug.

4. The load take-up device according to claim 1 wherein said bearing surface is a surface of said plate.

5. The load take-up device according to claim 1 comprising a stud secured to said plate, said bearing surface being a surface of said stud.

6. The load take-up device according to claim 1 wherein said element forming the bearing comprises a peripheral edge having at least one contact surface in an arc of circle of axis parallel to the axis of said screwing/unscrewing tool and intended to bear against said opposite surfaces of said wheel.

7. The load take-up device according to claim 6 wherein said peripheral edge comprises said contact surface in an arc of circle the opposite ends of which are joined by two flat and straight contact surfaces.

8. The load take-up device according to claim 2, comprising a holder, which holds in position said lug with respect to said plate in each of said positions of said lug.

9. The load take-up device according to claim 1 wherein said blocking element is removable and interchangeable from a group of a plurality of blocking elements adapted to different screwing/unscrewing tools.

10. The load take-up device according to claim 2 comprising at least one stud likely to be secured to said plate without said lug in order to form a second bearing surface intended to bear against one of the two opposite surfaces instead of said lug.

11. The load take-up device according to claim 5 wherein said stud is removable.

12. The load take-up device according to claim 10 wherein said at least one stud is removable.
